(19) United States
(12) Patent Application Publication
(10) Pub. No.: US 2024/0368931 A1
(43) Pub. Date: Nov. 7, 2024

(54) ASYMMETRICAL HINGE BASED COUNTERBALANCE MECHANISM

(71) Applicant: MAGNA CLOSURES INC., Newmarket (CA)

(72) Inventor: Thomas Wood, Newmarket (CA)

(21) Appl. No.: 18/653,391

(22) Filed: May 2, 2024

Related U.S. Application Data
(60) Provisional application No. 63/464,284, filed on May 5, 2023.

(51) Int. Cl. E05F 1/12

(52) U.S. Cl. CPC E05F 1/1238; E05Y 2201/624; E05Y 2900/531; E05Y 2900/546

(57) ABSTRACT

A hinge based counterbalance mechanism for operating a hinge of a closure panel of a vehicle to assist in opening and closing of the closure panel between a closed position and an open position, the hinge based counterbalance mechanism including: a pair of hinges each having a body side portion for connecting to a body of the vehicle and a panel side portion for connecting to the closure panel, the body side portion and the panel side portion coupled to one another by a respective mechanical coupling; a pair of torsion elements each having a free end coupled to a respective gear and a fixed end coupled to either of the body side portion or the body, the fixed end inhibited from rotating relative to the free end and the free end able to rotate about a torsion axis of the torsion element; wherein the pair of torsion elements are positioned relative to one another in a non-overlapping manner.

### FIELD

This disclosure relates to hinge based open and close mechanisms for a closure panel.

### BACKGROUND

Some vehicles are equipped with a closure panel, such as a lift gate, which is driven between an open position (position 2) and a closed position (position 1) using an electrically driven lift or opening system. Disadvantages of the current systems include bulky form factors which take up valuable vehicle cargo space, for example, occupying space along the vertical supports delimiting the opening of a rear liftgate. As such, the current systems tend to limit the size of access through the opening and into the interior cargo space, require additional lift support systems in tandem such as gas struts and other counterbalance mechanisms, have an unacceptable impact on manual open and close efforts requiring larger operator applied manual force at the panel handle, and/or temperature effects resulting in variable manual efforts required by the operator due to fluctuations in ambient temperature.

Automotive liftgates typically use struts for power operation. The counterbalance torques are provided by the springs and internal friction devices. In order to reduce the strut diameter and increase daylight opening of the aperture, the springs could be removed from the struts. The counterbalance torque must be provided by some other means.

### SUMMARY

It is an object of the present invention to provide a hinge based counterbalance mechanism that obviates or mitigates at least one of the above presented disadvantages.

One aspect provided is a hinge based counterbalance mechanism for operating a hinge of a closure panel of a vehicle to assist in opening and closing of the closure panel between a closed position and an open position, the hinge based counterbalance mechanism including: a pair of hinges each having a body side portion for connecting to a body of the vehicle and a panel side portion for connecting to the closure panel, the body side portion and the panel side portion coupled to one another by a respective mechanical coupling; a pair of torsion elements each having a free end coupled to a respective gear and a fixed end coupled to either of the body side portion or the body, the fixed end inhibited from rotating relative to the free end and the free end able to rotate about a torsion axis of the torsion element; wherein the pair of torsion elements are positioned relative to one another in a non-overlapping manner.

A second aspect provided is a method for coupling a closure panel to a body of a vehicle, the method comprising the steps of: provide a pair of hinges, each connected to both the closure panel by a respective panel side bracket and to the body by a respective body side bracket; provide a pair of torsion elements extending between the pair of hinges; configure a first mechanical coupling of a first hinge of the pair of hinges to be driven directly by a second torsion element of the pair of torsion elements; and configure a second mechanical coupling of a second hinge of the pair of hinges to be driven indirectly by a first torsion element of the pair of torsion elements.

The pair of torsion elements are positioned relative to one another in a non-overlapping manner.

Other aspects, including methods of operation, and other embodiments of the above aspects will be evident based on the following description and drawings.

### BRIEF DESCRIPTION OF THE DRAWINGS

Reference is made, by way of example only, to the attached figures, wherein:

FIG. 1A is a side view of a vehicle with one or more closure panels;

FIG. 1B is a rear perspective view of a vehicle with one or more closure panels illustrating the hinge based counterbalance mechanism positioned along a hinge axis;

FIG. 2 is an alternative embodiment of the vehicle of FIG. 1;

FIG. 3 is an alternative embodiment of the vehicle of FIG. 1;

FIG. 4A shows a perspective view of an embodiment of the hinge based counterbalance mechanism of FIG. 1B;

FIG. 4B shows a further view of the hinge based counterbalance mechanism of FIG. 4A;

FIG. 5 shows a further view of the hinge based counterbalance mechanism of FIG. 4B;

FIG. 6 shows a further view of the hinge based counterbalance mechanism of FIG. 5;

FIG. 7 shows side views of each hinge of the hinge based counterbalance mechanism of FIG. 1B;

FIGS. 8A,B show perspective views of the hinges of the hinge based counterbalance mechanism of FIG. 1B with multi bar linkage;

FIGS. 9A,B show various positions of operation of the hinge of the hinge based counterbalance mechanism of FIG. 1B;

FIG. 10 shows an example of indirect coupling of one the torsion elements to a multibar linkage of the hinge based counterbalance mechanism of FIG. 1B;

FIG. 11 shows an example of direct coupling of one the torsion elements to a multibar linkage of the hinge based counterbalance mechanism of FIG. 1B;

FIG. 12 shows an example installation in a vehicle of the hinge based counterbalance mechanism of FIG. 1B;

FIG. 13 is a graph of torque values showing comparison between torsion rod and liftgate torque as compared to target output torque for operational parameters of the hinge based counterbalance mechanism of FIG. 1B; and

FIG. 14 shows an example method of the hinge based counterbalance mechanism of FIG. 1B.

### DETAILED DESCRIPTION OF EXAMPLE EMBODIMENTS

In this specification and in the claims, the use of the article “a”, “an”, or “the” in reference to an item is not intended to exclude the possibility of including a plurality of the item in some embodiments. It will be apparent to one skilled in the art in at least some instances in this specification and the attached claims that it would be possible to include a plurality of the item in at least some embodiments. Likewise, use of a plural form in reference to an item is not intended to exclude the possibility of including one of the item in some embodiments. It will be apparent to one skilled in the art in at least some instances in this specification and the attached claims that it would be possible to include one of the item in at least some embodiments.

In the following description, details are set forth to provide an understanding of the disclosure. In some instances, certain software, circuits, structures, techniques and methods have not been described or shown in detail in order not to obscure the disclosure. The term “controller” is used herein to refer to any machine for processing data, including the data processing systems, computer systems, modules, electronic control units (“ECUs”), microprocessors or the like for providing control of the systems described herein, which may include hardware components and/or software components for performing the processing to provide the control of the systems described herein. A computing device is another term used herein to refer to any machine for processing data including microprocessors or the like for providing control of the systems described herein. The present disclosure may be implemented in any computer programming language (e.g. control logic) provided that the operating system of the control unit provides the facilities that may support the requirements of the present disclosure. Any limitations presented would be a result of a particular type of operating system or computer programming language and would not be a limitation of the present disclosure. The present disclosure may also be implemented in hardware or in a combination of hardware and software.

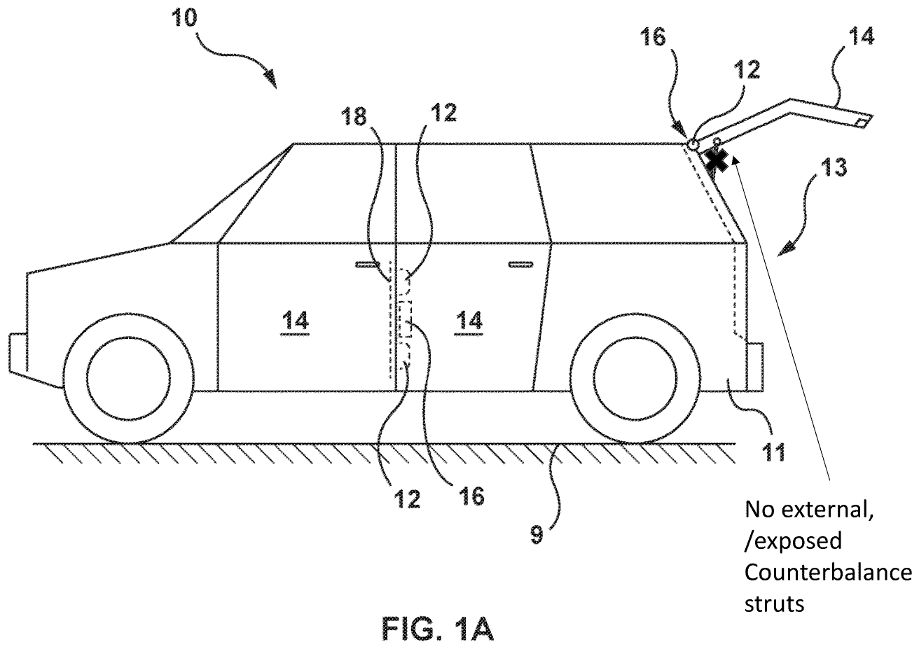

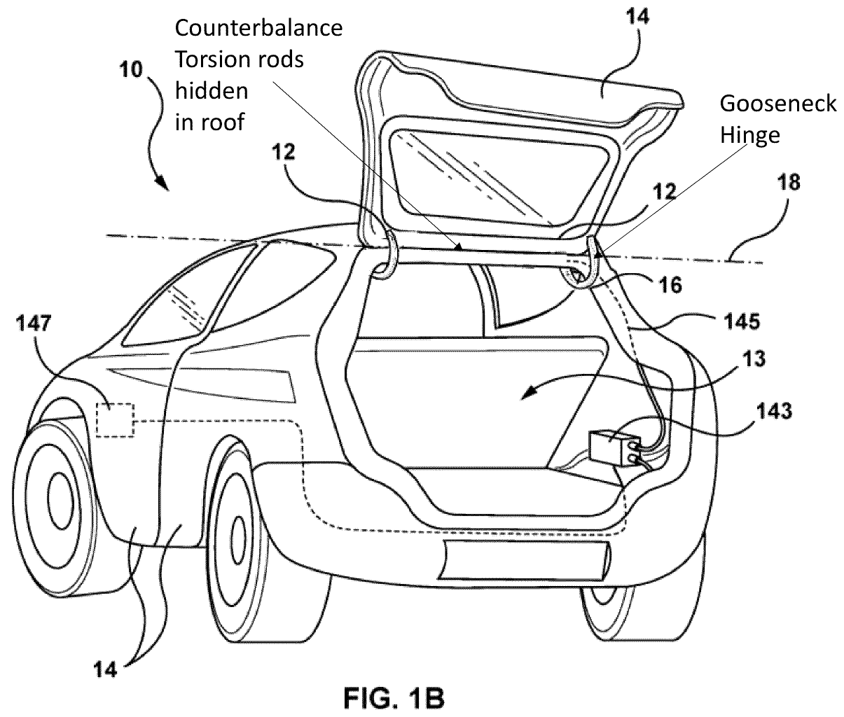

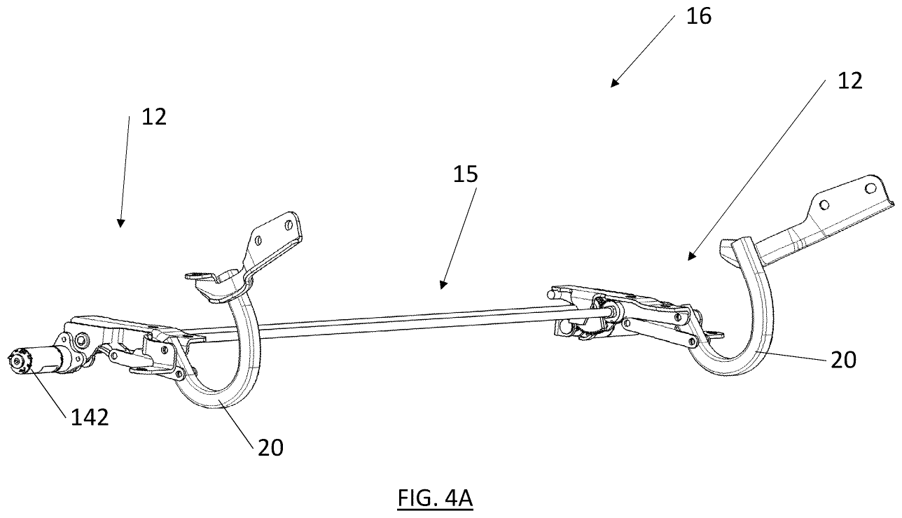

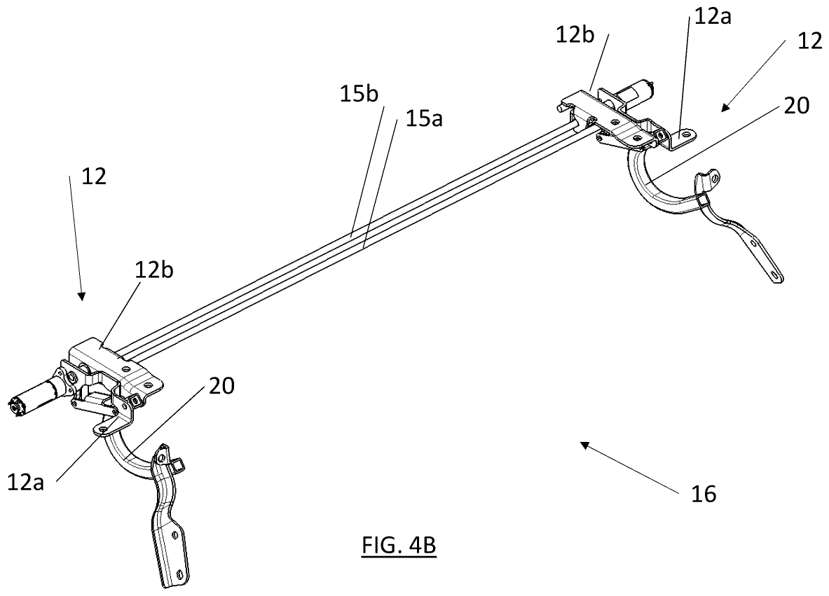

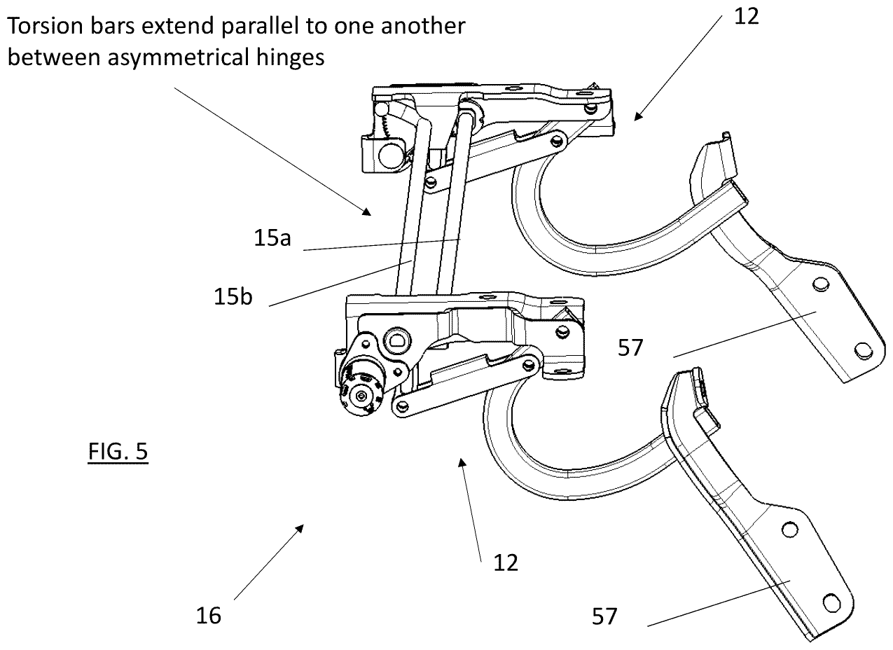

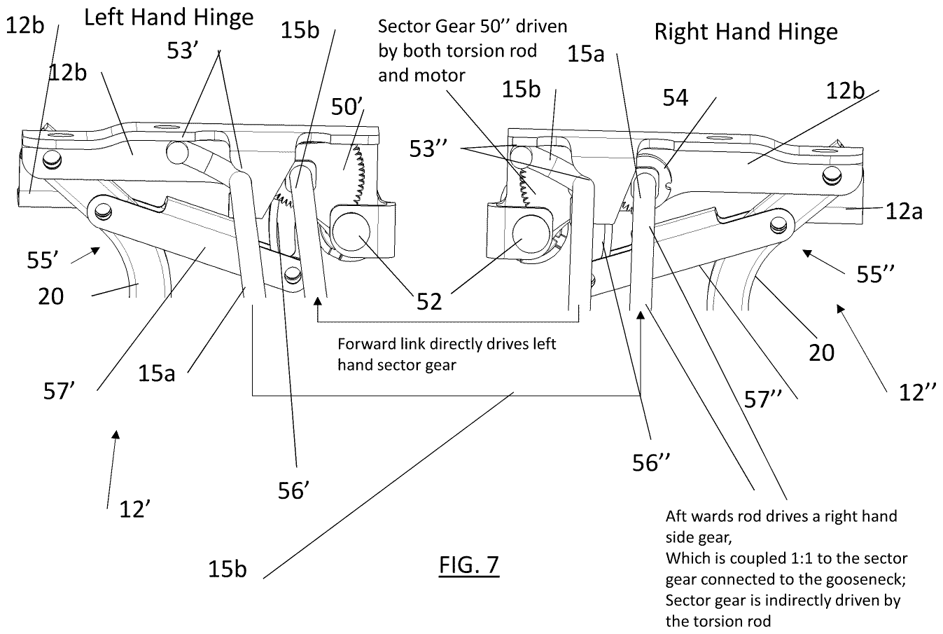

Referring to FIGS. 1A and 1B, provided is a hinge based counterbalance mechanism 16 (e.g. configured using one or more torsion elements 15—see FIG. 4b) that can be used advantageously with vehicle closure panels 14 to provide for open and close operations for the closure panel(s) 14 of vehicles 10. Other applications of the hinge based counterbalance mechanism 16, in general for closure panels 14 both in and outside of vehicle applications, include advantageously assisting in optimization of overall hold and manual effort forces for closure panel 14 operation. It is recognized as well that the hinge based counterbalance mechanism 16 examples provided below can be used advantageously as the sole means of open and close assistance for closure panels 14 or can be used advantageously in combination (e.g. in tandem) with other closure panel 14 biasing members (e.g. spring loaded hinges, biasing struts, etc.). In particular, the hinge based counterbalance mechanism 16 can be used to provide or otherwise assist in a holding force (or torque) for the closure panel 14. Further, it is recognized that the hinge based counterbalance mechanism 16 can be integrated in conjunction with hinges 12 (see FIGS. 1b,4b) of the closure panel 14 such as a component of a closure panel 14 assembly, as further described below. The hinges 12 can have a panel side portion 12a for connecting the hinge based counterbalance mechanism 16 to the closure panel 14 and a body side portion 12b for connecting the hinge based counterbalance mechanism 16 to a vehicle body 11. For example, the panel side portion 12a can be connected a gate bracket 20 (se FIG. 4A). The torsion element(s) 15 of the direct hinge drive mechanism 16 can be of a solid bar or hollow tube type, as desired. Further, the torsion elements 15 can be a resilient element (e.g. such as a coil spring). Further, it is recognized that the panel side portion 12a and the gate bracket 20 can be part of a multibar linkage 55′, 55″ (see FIG. 7 by example), as further described below. Further, the gate bracket 20 can be connected to the closure panel 14 by panel brackets 57 (see FIG. 5).

The hinge 12 of FIG. 1B, for example can include a gooseneck, and as shown the pari of torsion elements 15 can be positioned in an internal cavity (e.g. interior) of the body 11 of the vehicle 10.

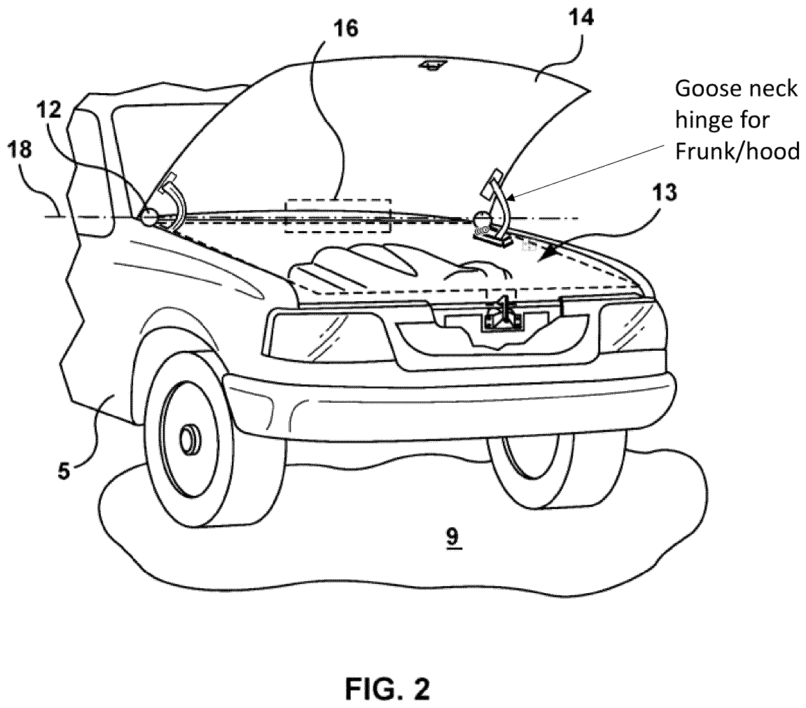

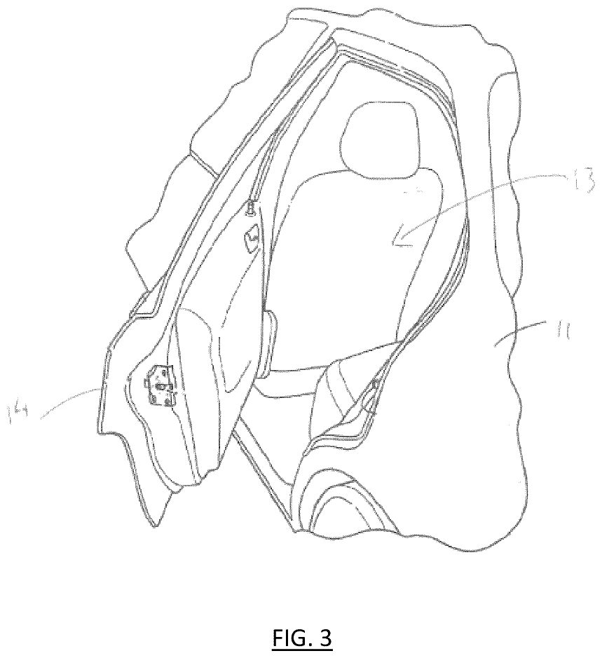

Referring again to FIGS. 1A and 1B, shown is the vehicle 10 with a vehicle body 11 having one or more closure panels 14. For vehicles 10, the closure panel 14 can be referred to as a partition or door, typically hinged, but sometimes attached by other mechanisms such as tracks, in front of an opening 13 which is used for entering and exiting the vehicle 10 interior by people (see FIG. 3) and/or cargo. It is also recognized that the closure panel 14 can be used as an access panel for vehicle 10 systems such as engine compartments (see FIG. 2) and also for traditional trunk compartments of automotive type vehicles 10. The closure panel 14 can be opened to provide access to the opening 13, or closed to secure or otherwise restrict access to the opening 13. For example decklids, frunks, hoods, tailgates. Also closure panel 14 can be for a center console with hinged lid configuration, glove compartments, pickup truck covers, windows and the like. It is also recognized that there can be one or more intermediate hold positions of the closure panel 14 between a fully open position and fully closed position, as provided at least in part by the torsion element 15. For example, the torsion element 15 can assist in biasing movement of the closure panel 14 away from one or more intermediate hold position(s), also known as Third Position Hold(s) (TPHs) or Stop-N-Hold(s), once positioned therein. It is also recognized that the torsion element(s) 15 can be provided as a component of the closure panel 14 assembly. The frunk as the closure panel 14 can also include a gooseneck, as desired (see FIG. 2).

The closure panel 14 can be opened manually and/or powered electronically via the hinge based counterbalance mechanism 16, where powered closure panels 14 can be found on minivans, high-end cars, or sport utility vehicles (SUVs) and the like. Additionally, one characteristic of the closure panel 14 is that due to the weight of materials used in manufacture of the closure panel 14, some form of force assisted open and close mechanism (or mechanisms) are used to facilitate operation of the open and close operation by an operator (e.g. vehicle driver) of the closure panel 14. The force assisted open and close mechanism(s) can be provided by the torsion element(s) 15, a motor 142 (see FIG. 4a), and/or any biasing members external to the hinge based counterbalance mechanism 16 (e.g. spring loaded hinges, spring loaded struts, gas loaded struts, electromechanical struts, etc.), when used as part of the closure panel 14 assembly. In an embodiment, the torsion element(s) 15, a motor 142 may provide both the force assist and counterbalance for the closure panel 14 assembly. In other words, there are no external/exposed counterbalance struts positioned between the closure panel 14 and the body 11 of the vehicle 10.

In terms of vehicles 10, the closure panel 14 may be a lift gate as shown in FIGS. 1A and 1B, or it may be some other kind of closure panel 14, such as an upward-swinging vehicle door (i.e. what is sometimes referred to as a gull-wing door) or a conventional type of door that is hinged at a front-facing or back-facing edge of the door (see FIG. 3), and so allows the door to swing (or slide) away from (or towards) the opening 13 in the body 11 of the vehicle 10. Canopy doors are a type of door that sits on top of the vehicle 10 and lifts up in some way, to provide access for vehicle passengers via the opening 13 (e.g. car canopy, aircraft canopy, etc.). Canopy doors can be connected (e.g. hinged at a defined pivot axis and/or connected for travel along a track) to the body 11 of the vehicle at the front, side or back of the door, as the application permits.

Referring again to FIG. 1A, in the context of a vehicle application of a closure panel by example only, the closure panel 14 is movable between a closed position (shown in dashed outline) and an open position (shown in solid outline). In the embodiment shown, the closure panel 14 pivots between the open position and the closed position about a pivot axis 18 (see FIG. 2), which can be configured as horizontal or otherwise parallel to a support surface 9 of the vehicle 10. In other embodiments, the pivot axis 18 may have some other orientation such as vertical (see FIG. 1A) or otherwise extending at an angle outwards from the support surface 9 of the vehicle 10.

Referring to 4B, 5, and 6, shown is the hinge based counterbalance mechanism 16 having a pair of torsion elements 15a (e.g. one for each hinge 12) coupled on one end to a hinge 12 and on the other end to the other hinge 12.

Torsion elements/bars 15a,b extend preferably parallel to one another between the hinges 12 (see FIG. 5). As such, there can be no overlap (e.g. non overlap positioning relative between the torsion rods 15a,b) or bend in the torsion rods 15a,b, as they are spaced apart from one another (e.g. the elements 15a,b do not cross one another, are uncrossed with respect to one another, etc.). Different sized torsion rods 15a,b can be used. Further, the hinges 12 are not symmetrical (unsymmetrical) to provide for the 15a,b rods to extend alongside one another without crossing (e.g. parallel to one another), see FIG. 7, without bends or crossing. On one hand, the torsion rod 15a drives the linkage directly. On the other hand, the torsion rod 15b drives the linkage through the (e.g. 1:1) gear relationship (e.g. gears 50″, 54). In this manner, the configuration of the hinges 12′, 12″ are considered asymmetrical.

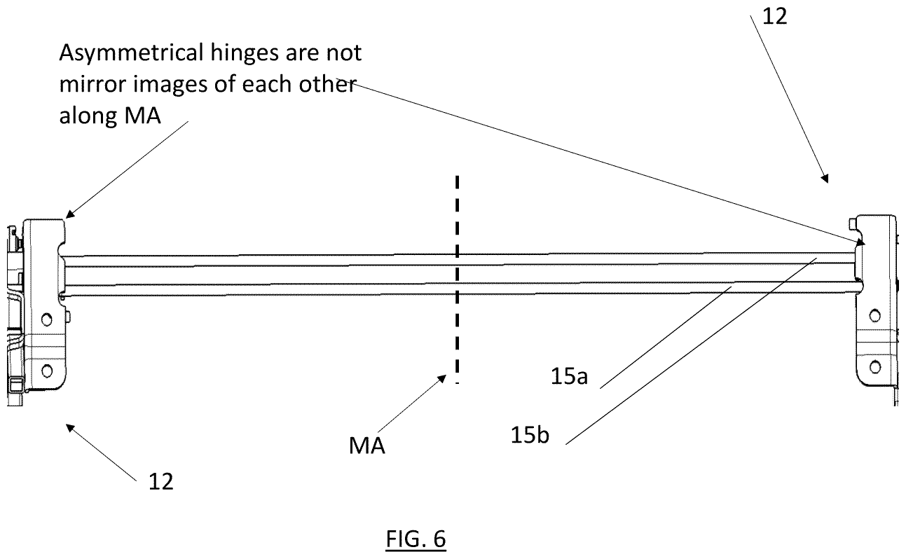

In other words, as further described below by example—see FIGS. 4A, 6, each end of the set of torsion bars 15 are not mirror images of one another along the MA. For example, when each of the pair of hinges 12 are viewed a position between the hinges 12, such as along line MA for example as seen in FIG. 7, each hinge 12 will appear with a different configuration than the other, without having identical components and component placements. For example as shown in FIG. 7, the right hand hinge is configured with an extra component, for example is provided with a gear 54, while the left handle hinge is not. For example as shown in FIG. 7, torsion bar 15a is configured to abut an abutment 53″ of the right hand hinge that is located at a different position and configuration than abutment 53′ of the left hand hinge. Illustratively, the abutment 53″ of the right hand hinge is proximate an end of the hinge 12b, while the abutment 53′ of the left hand hinge is located within a central portion of the hinge 12b. On a respective first end of the torsion bar set 15, one torsion bar 15a will be secured directly (e.g. fixed) against a respective body side portion 12b while the other torsion bar 15b will be indirectly secured (e.g. non-fixed, able to rotate relative to the fixed end) via one or more gears (e.g. sector gear 50′). Similarly, on a respective second end (opposite the first end) of the torsion bar set 15, the torsion bar 15b will be secured directly against a respective body side portion 12b while the other torsion bar 15a will be indirectly secured via one or more gears (e.g. sector gear 50′). In this manner, the torsion bar set 15 is considered to facilitate the hinges 12′, 12″ to be in an asymmetrical configuration.

For example, the pair of hinges 12′, 12″ can be configured as asymmetrical to one another, such that the free end of the torsion bar set 15 and the fixed end of the torsion bar set 15 (on the same side of the torsion bar set 15) are positioned adjacent to one another in relation to the same hinge (e.g. 12′ or 12″) of the pair of hinges 12′, 12″.

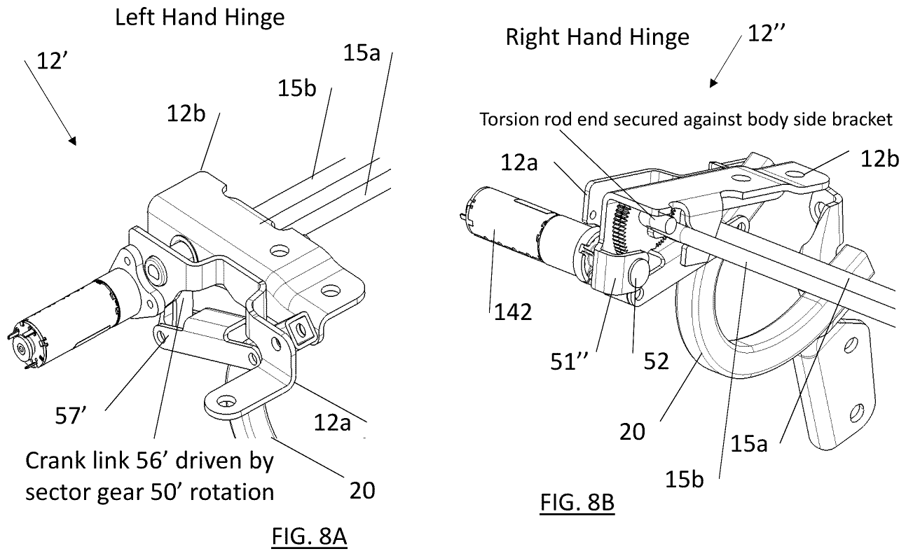

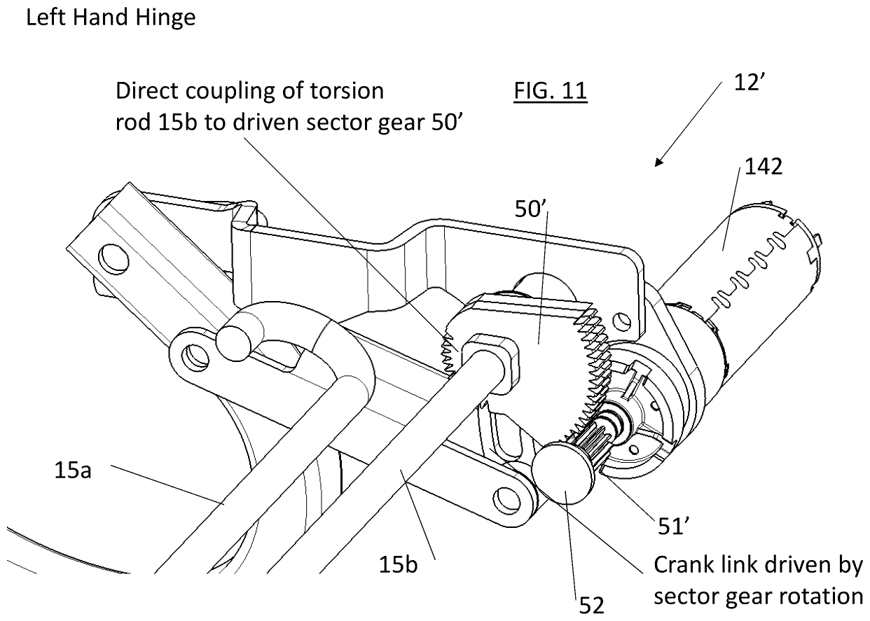

For example, referring to FIGS. 7, 8A, 8B, a first side hinge 12′ (e.g. left side hinge) and a second side hinge 12″ (e.g. right side hinge) are shown. The first side hinge 12′ has a first torsion element 15a secured (e.g. using abutment(s) 53′ of the body side portion 12b) against the respective body side portion 12b and the second torsion element 15b is directly coupled to a first sector gear 50′, which is also connected to the motor 142 of first side hinge 12′ (e.g. via gear 51′ mounted on drive shaft 52—see FIG. 11). In the right hand hinge 12″ of FIG. 8B, the torsion rod 15b is secured against the body side bracket 12a. In FIG. 8A, the crank link 56′ is driven by the sector gear 50′ rotation as the pair of hinges 12′,12″ is operated between the open and close positions of the closure panel 14.

The second side hinge 12″ has a second torsion element 15b secured (e.g. using abutment(s) 53″ of the body side portion 12b) against the respective body side portion 12b and the first torsion element 15a is indirectly coupled to a second sector gear 50″, which is also connected to the motor 142 of second side hinge 12″ (e.g. via gear 51″ mounted on drive shaft 52—see FIG. 8b).

Further, referring again to FIG. 7, the second side hinge 12″ has a sector gear 50″ driven indirectly by the torsion element 15a (via coupling gear 54 mounted on body side portion 12b) and also directly via the drive shaft 52 (and gear 51″) of the respective motor 142. Further, the sector gear 50″ is coupled to the closure panel via a multibar linkage 55″ (e.g. consisting of gooseneck 20, side panel portion 12a, crank link 56″ and rocker link 57″). The crank link 56″ is driven by movement (e.g. rotation) of the sector gear 50″ (see FIG. 8B also).

Referring again to FIG. 7, the left hand hinge 12′ and the right hand hinge 12″ are positioned such that the forward link (e.g. rod 15a) positioned towards the front of the vehicle 10 directly drives the left hand sector gear 50′. Similarly, rearward link (e.g. rod 15a) positioned towards the rear of the vehicle 10 directly drives the right hand sector gear 50″. Further, it can be seen that the sector gear 50″ is drive by both the torsion rod 15a and the respective motor 52. The torsion rods 15 can be attached to their respective goosenecks using a 1:1 coupling-via their respective sector gear 50′,50″. It is also noted that the sector gear 50′,50″ is indirectly driven by the respectively attached torsion rod 15.

Further, first side hinge 12′ has a sector gear 50′ to drive directly the torsion element 15b and is also directly driven via the drive shaft 52 (and gear 51′) of the respective motor 142. Further, the sector gear 50′ is coupled to the closure panel via a multibar linkage 55′ (e.g. consisting of respective gooseneck 20, side panel portion 12a, crank link 56′ and rocker link 57′). The crank link 56′ is driven by movement (e.g. rotation) of the sector gear 50′ (see FIG. 8A also).

In the situations described above, it is recognised that the torsion element 15b on one end is directly coupled (for rotation/torsion) to sector gear 50′ of the first side hinge 12′ and the torsion element 15b is fixed (for non rotation) to side body portion 12b of the second side hinge 12″ via abutments(s) 53″. On the contrary, the torsion element 15a on one end is indirectly coupled (for rotation/torsion) to sector gear 50″ of the second side hinge 12″ and the torsion element 15a is fixed (for non rotation) to side body portion 12b of the first side hinge 12′ via abutments(s) 53′. In this manner, it is considered that the arrangement of the torsion elements 15a,b is nonsymmetrical with respect to the two hinges 12′,12″.

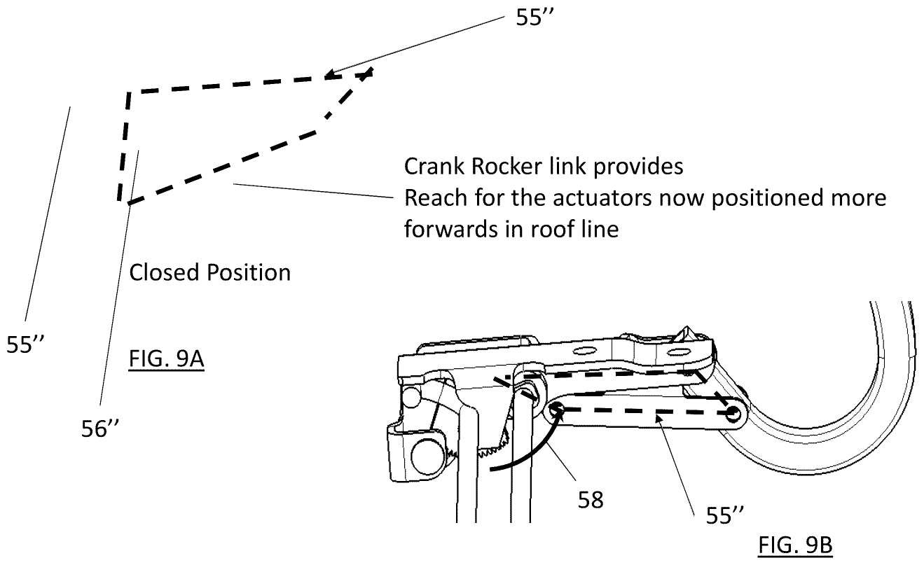

Referring to FIGS. 9A, 9B, the second side hinge 12″ is shown, both in a closed position and an open position. As noted, the multibar linkage 55″ (also referred to in dotted lines) is operated by the crank link 56″ as the sector gear 50″ is rotated 58 by the motor 142 (see FIG. 11). Further, the crank rocker link 56′,56″ can provide reach for the motors/actuators 142 now positioned more towards the front end of the vehicle 10 (in the roofline).

In reference to FIGS. 9A,B, it is recognised that the sector (e.g. common) gear 50″ can receive force input from both the motor 142 and the torsion rod 15a (via gear 54). For example, the gearing teeth can receive input from the actuators (motor 142 & and rods 15a,b), which are distributed horizontally (e.g. in parallel arrangement) where space in the roof line is less restricted, as compared to a vertical distribution of the actuators when positioned in a cross over or otherwise overlapped arrangement. Further, the crank rocker link 56′, 56″ provides reach for the actuators now positioned more forwards in roof line as compared to the overlapped arrangement as know in the art. Further, since larger diameter torsion rods 15a,b can be used, as compared to the know overlapped arrangement, the geared interface can be increased in strength against higher torque, compared to prior rivet connections.

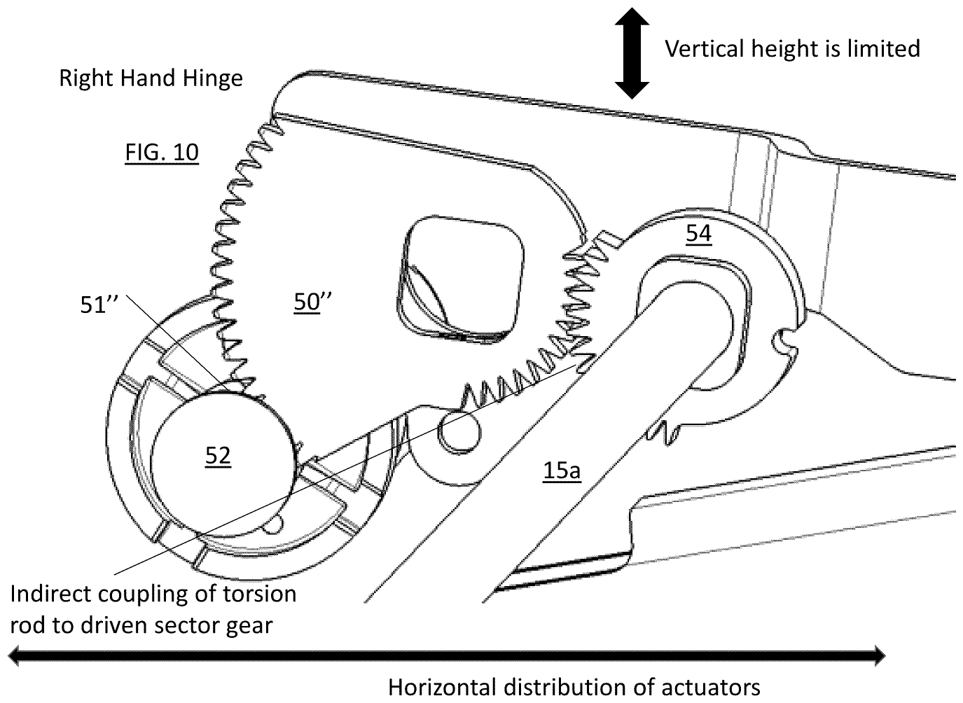

FIG. 10 shows an example of indirect coupling of one the torsion elements 15a to a multibar linkage 55′,55″ of the hinge based counterbalance mechanism 16 of FIG. 1B. In this manner of configuration, the vertical height of the counterbalance mechanism 16 is reduced (as compared to a crossed/overlapping configuration of the pair of torsion elements 15). In this manner, the non-overlapping of the pair of torsion elements 15 provides for the torsion elements 15a,b to be spaced apart from one another in a horizontal direction (e.g. a direction lateral to the vertical direction) as well as the spacing of the actuators 142. As can be seen, there is an indirect coupling (e.g. using a gear 54 mounted on the end of the torsion element 15a) between the torsion element 15a and the driven sector gear 50″.

FIG. 11 shows an embodiment whereby the left hand hinge 12′ has a direct coupling of the torsion element 15b to the driven sector gear 50′. Further, a crank link 56′ is also driven by the sector gear 50′ rotation.

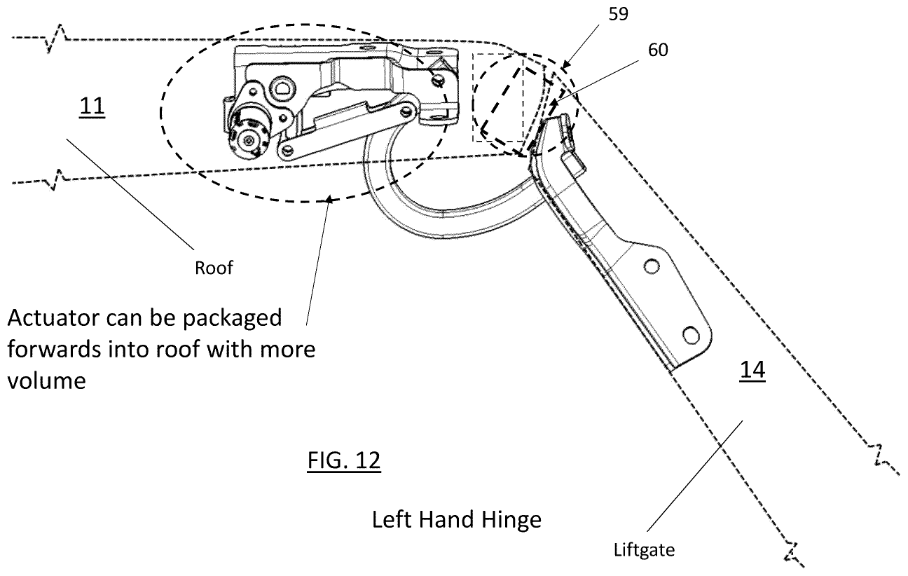

Referring to FIG. 12, the area 59 in the roof 11 (i.e. closer to the liftgate 14) has less packaging room, for example if the roof 11 has a slope when a prior art powered bracket hinge (e.g. using an overlapped torsion element configuration) is installed. Due to the sloping roof 11 of many vehicles 10, the hinges (e.g. non actuated) are normally installed flat in the rear of the vehicle 10. The rectangle 60 shown represents the previous compact design for non-actuated hinges. The gooseneck 20 design of the hinges 12′,12″ can provide advantageously for the components of the actuated hinges 12′,12″ to be moved around and packaged as needed within the roof 11 of the vehicle 10. In short, one advantage of the new design hinges 12′, 12″ is greater packaging flexibility, such that the actuator 142 can be packaged more forward towards the front of the vehicle 10 where more volume in the interior fo the roofline can be provided.

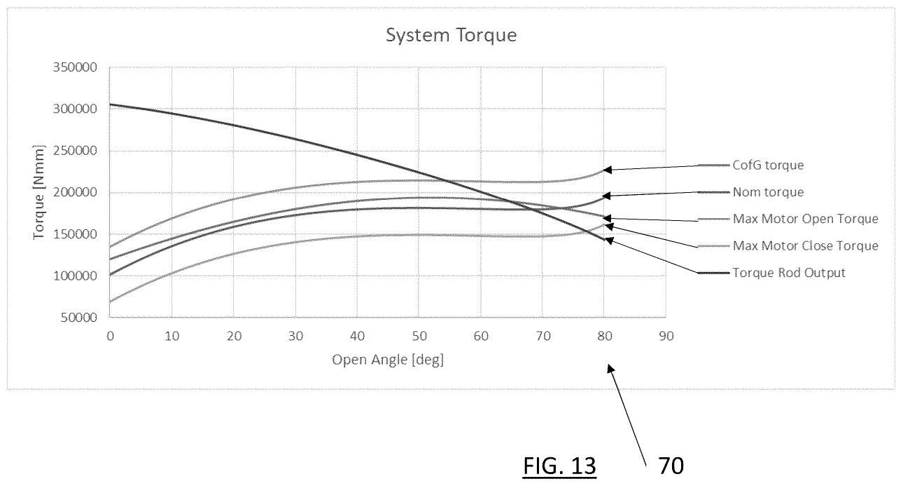

FIG. 13 shows a system torque vs open angle diagram 70, in particular showing the torsion element 15a,b output to the multibar linkages 55′,55″ as the closure panel 14 is opened from the closed position to the open position.

As shown by example, the respective torsion element 15a,b associated with each hinge 12′,12″ is twisted or untwisted, thus loading or unloading (depending on the direction of rotation) torque of the torsion element 15a,b. It is recognized that at one free end (coupled to the respective sector gear 50′,50″) the torsion element 15a,b is allowed to rotate (about a respective torsion axis running along a longitudinal centerline of the respective torsion element 15a,b) while at the other fixed end (adjacent to the abutments 53′,53″) the torsion element 15a,b is fixedly mounted to the other body side portion 12b of the pair of hinges 12′, 12″ and thus inhibited from rotating.

As provided above, for example, a pair of torsion elements 15a,b are used-one providing torque to each hinge 12 of the pair of hinges 12′,12″ coupling the closure panel 14 to the vehicle body 11. The torsion element 15 output torque can be applied to the hinge 12′, 12″ via the multi (e.g. 4) bar linkage 55′,55″ (an example of a mechanical coupling mechanism between the hinge 12′,12″ and the closure panel 14). The use of the mechanical coupling mechanism facilitates variability in mechanical advantage between the operational coupling of the torsion elements 15 with the panel side portion 12a of the hinge 12, which provides as the closure panel 14 open/closes a match with the closure panel 14 torque curve and thus the provision of counterbalance. Because the closure panel 14 is facilitated as balanced, advantageously a smaller motor 142 can be packaged at the hinge 12 to provide the additional torque used to open/close the closure panel 14. The torsion element 15 counterbalance can reduce the size/power needed for the gear 50′,50″ and motor 142 assembly. It is also recognized that hinge based counterbalance mechanism 16 with the torsion elements 15 could be used as a manual only option (e.g. without motors 142), or combined with the motor(s) 142 or a powered system option. Advantageously, the hinge based counterbalance mechanism 16 can be resistant to moisture or temperature variability, due to the stability provided by torsion elements 15, for example which may be illustratively manufactured using metal to provide thermal stability as an example.

As such, the hinge based counterbalance mechanism 16 can be designed as a torsion rod system packaged near the closure panel 14 to provide the torques used to balance (i.e. counterbalance) the closure panel 14 at a plurality (e.g. all) opening/closing positions. For example, as a torsion element 15 can have a linear torque output, while the closure panel 14 torque curve is non-linear, the use of the mechanical coupling system provides for the variability (i.e. non-linear output) in mechanical advantage between the torsion element 15 and the closure panel 14 via the panel side portion 12a of the hinge 12.

In view of the above, the hinge based counterbalance mechanism 16 can be for operating hinges 12 of the closure panel 14 of the vehicle 10 to assist in opening and closing of the closure panel 14 between the closed position and the open position about the pivot axis 18. The hinge based counterbalance mechanism 16 can include: the first hinge 12′ and the second hinge 12″ each having the body side portion 12b for connecting to the body 11 of the vehicle 10 and the panel side portion 12a for connecting to the closure panel 14, the body side portion 12b and the panel side portion 12a coupled via the pivot axis 18; a first torsion element 15a having a first fixed end coupled to the body 11 (e.g. the body side portion 12b) and a first free end coupled to the sector gear 50″ of the second hinge 12″, the first fixed end inhibited from rotating relative to the first free end and the first free end able to rotate about a first torsion axis of the first torsion element 15a; a second torsion element 15b having a second fixed end coupled to the body 11 (e.g. the body side portion 12b) and a second free end coupled to the sector gear 50′ of the first hinge 12′, the second fixed end inhibited from rotating relative to the second free end and the second free end able to rotate about a second torsion axis of the second torsion element 15b; a first mechanical coupling mechanism 55′ coupling the second free end to the panel side portion 12a of the first hinge 12′, the first mechanical coupling mechanism 55′ providing for variability in torque output applied from the second torsion element 15b to the panel side portion 12a of the first hinge 12′ as the first hinge 12′ moves between the open position and the closed position; and a second mechanical coupling mechanism 55″ coupling the first free end to the panel side portion 12a of the second hinge 12″, the second mechanical coupling mechanism 55″ providing for variability in torque output of the first torsion element 15a applied from the first torsion element 15a to the panel side portion 12a of the second hinge 12″ as the second hinge 12″ moves between the open position and the closed position.

Further, as shown, the first fixed end can be mounted to the body side portion 12b of the hinge 12′ and the second fixed end can be mounted to the body side portion of the other hinge 12″. Alternatively, the fixed ends can be mounted directly to the body 11 rather than indirectly via the body side portion 12b (not shown). In any event, it is recognized that the fixed end is inhibited from rotating relative to the free end for each of the torsion elements 15a,b.

Illustratively, referring to FIGS. 1B, 8A,B, the motor 142 can be controlled by a controller 143 in electrical communication therewith via signal lines 145 for issuing pulse width modulated control signals for controlling the rotational direction of the motor 142, the speed of the motor 142, the stopping of the motor 142 for obstacle detection, and other functionalities for controlling the movement of the closure panel 14. Other types of motors, such as brushless motors controlled using Field Oriented Control (vector control) techniques may also be provided, as an example. The controller 143 may draw power from a source of electric energy, such as the vehicle main battery 147.

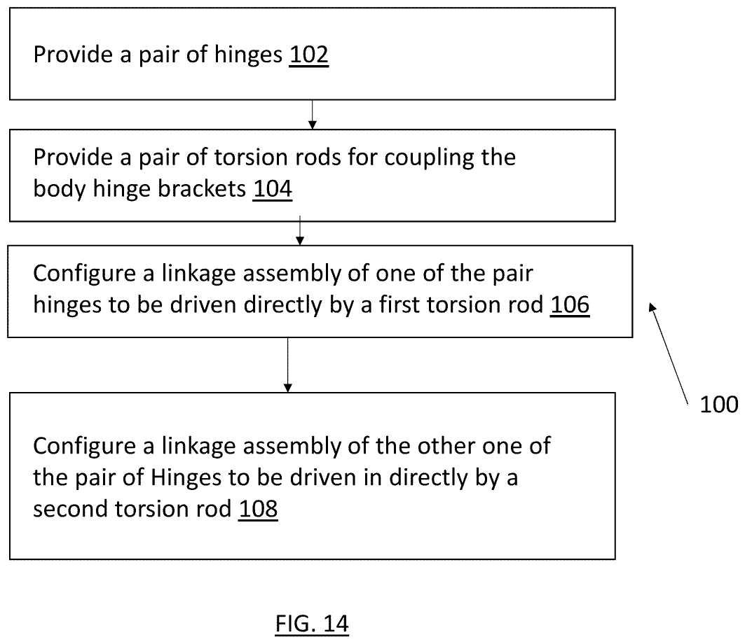

Referring to FIG. 14, a method 100 for coupling a closure panel 14 to a body 11 of a vehicle 10, the method 100 comprising the steps of: provide 102 a pair of hinges 12′,12″, each connected to both the closure panel 14 by a respective panel side bracket 12a and to the body 11 by a respective body side bracket 12b; provide 104 a pair of torsion elements 15a,b extending between the pair of hinges 12′,12″; configure 106 a first mechanical coupling 55′ of a first hinge 12′ of the pair of hinges 12′, 12″ to be driven directly by a second torsion element 15b of the pair of torsion elements 15a,b; and configure 108 a second mechanical coupling 55″ of a second hinge 12″ of the pair of hinges 12′, 12″ to be driven indirectly by a first torsion element 15a of the pair of torsion elements 15a,b.

We claim:

1. A hinge based counterbalance mechanism (16) for operating a hinge (12) of a closure panel (14) of a vehicle (10) to assist in opening and closing of the closure panel between a closed position and an open position, the hinge based counterbalance mechanism including:
a pair of hinges (12′, 12″) such that each hinge of the pair of hinges having a body side portion (12b) for connecting to a body (11) of the vehicle and a panel side portion (12a) for connecting to the closure panel, the body side portion and the panel side portion coupled to one another by a respective mechanical coupling (55′, 55″);
a pair of torsion elements (15a, 15b) each having a free end coupled to a respective gear (50′,50″) and a fixed end coupled to either of the body side portion or the body, the fixed end inhibited from rotating relative to the free end and the free end able to rotate about a torsion axis of the torsion element;
wherein the pair of torsion elements are positioned relative to one another in a non-overlapping manner.

2. The mechanism of claim 1, wherein the respective mechanical coupling mechanism is a multi-bar linkage.

3. The mechanism of claim 2, wherein the multi-bar linkage includes a gooseneck.

4. The mechanism of claim 1, wherein the torsion element is a solid rod or a hollow tube.

5. The mechanism of claim 1, wherein the closure panel is selected from the group consisting of: a lift gate; and a swing door.

6. The mechanism of claim 1, wherein each of the torsion elements are linear in length along their respective torsion axis.

7. The mechanism of claim 1, wherein the pair of hinges are configured as asymmetrical to one another, such that said free end and said fixed end are positioned adjacent to one another in relation to the same hinge of the pair of hinges.

8. The mechanism of claim 1, wherein the pair of torsion elements are positioned parallel to one another, thus providing the non-overlapping manner.

9. The mechanism of claim 1, wherein a first free end of a first torsion element of the pair of torsion elements is indirectly connected to a second gear of a second hinge of the pair of hinges and a second free end of a second torsion element of the pair of torsion elements is directly connected to a first gear of a first hinge of the pair of hinges.

10. The mechanism of claim 2, wherein the multibar linkage includes a crank link driven by rotation of a gear coupled to a respective one of the pair of torsion elements.

11. A method for coupling a closure panel to a body of a vehicle, the method comprising the steps of:
provide a pair of hinges, each connected to both the closure panel by a respective panel side bracket and to the body by a respective body side bracket;
provide a pair of torsion elements extending between the pair of hinges;
configure a first mechanical coupling of a first hinge of the pair of hinges to be driven directly by a second torsion element of the pair of torsion elements; and
configure a second mechanical coupling of a second hinge of the pair of hinges to be driven indirectly by a first torsion element of the pair of torsion elements;
wherein the pair of torsion elements are positioned relative to one another in a non-overlapping manner.

12. The method of claim 11, wherein the first and second mechanical coupling mechanisms are multi-bar linkages.

13. The method of claim 12, wherein the multi-bar linkages include a gooseneck.

14. The method of claim 11, wherein one or more of the pair of torsion elements is a solid rod or a hollow tube.

15. The method of claim 11, wherein the closure panel is selected from the group consisting of: a lift gate; and a swing door.

16. The method of claim 11, wherein each of the torsion elements are linear in length along their respective torsion axis.

17. The method of claim 11 further comprising operating the pair of hinges in an asymmetrical manner to one another, such that a free end of the first torsion element and a fixed end of the second torsion element are positioned adjacent to one another in relation to the same hinge of the pair of hinges.

18. The method of claim 11, wherein the pair of torsion elements are positioned parallel to one another, thus providing the non-overlapping manner.

19. The method of claim 11, wherein a first free end of the first torsion element of the pair of torsion elements is indirectly connected to a second gear of the second hinge of the pair of hinges and a second free end of the second torsion element of the pair of torsion elements is directly connected to a first gear of the first hinge of the pair of hinges.

20. A hinge based counterbalance mechanism (16) for operating a hinge (12) of a closure panel (14) of a vehicle (10) to assist in opening and closing of the closure panel between a closed position and an open position, the hinge based counterbalance mechanism including:
a pair of hinges (12′, 12″) such that each hinge of the pair of hinges having a body side portion (12b) for connecting to a body (11) of the vehicle and a panel side portion (12a) for connecting to the closure panel, the body side portion and the panel side portion coupled to one another by a respective mechanical coupling (55′, 55″);
a pair of torsion elements (15a, 15b) each having a free end coupled to a respective gear (50′,50″) and a fixed end coupled to either of the body side portion or the body, the fixed end inhibited from rotating relative to the free end and the free end able to rotate about a torsion axis of the torsion element; wherein the pair of torsion elements are positioned relative to one another in a parallel manner;
wherein the pair of hinges are not mirror images of one another when viewed from a position between the hinges when the pair of torsion elements (15a, 15b) are coupled to the pair of hinges.
